(19) United States
(12) Patent Application Publication
(10) Pub. No.: US 2008/0125946 A1
(43) Pub. Date: May 29, 2008

(54) PREDICTIVE DETERMINATION OF A GEAR RATIO CHANGE

(75) Inventors: Winfried FAKLER, Friedrichshafen (DE); Thomas Voss, Langenargen (DE); Harald Deiss, Ravensburg (DE); Armin Gierling, Langenargen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/771,438

(22) Filed: Jun. 29, 2007

(30) Foreign Application Priority Data
Jul. 1, 2006 (DE) 10 2006 030 528.0

(51) Int. Cl. F16H 59/00; G06F 17/00

(52) U.S. Cl. 701/62

(57) ABSTRACT

A method for predictive determination of gear ratio changes in an electronically controlled transmission. Environment data (12), driver/vehicle data (11) and information about a first proposed gear (10) are fed to a correcting module (13) which comprises at least one driving situation module (14) and a determining module (15). The determining module (15) evaluates, in a first step (2), whether at least one shifting situation for a procedure exists. If at least one shifting situation exists, evaluating, in a second step (6), whether also the conditions for carrying out the respective procedure for one of the detected shifting situations exist. If a shifting situation has occurred and the conditions for performing a procedure exist, the first proposed gear (10) is adapted in a third step and an adapted second proposed gear (17) is determined, the information of which is forwarded to the transmission (18).

This application claims priority from German Application Serial No. 10 2006 030 528.0 filed Jul. 1, 2006.

### FIELD OF THE INVENTION

The invention relates to the predictive determination of a gear ratio change for electronically controlled transmissions in motor vehicles.

### BACKGROUND OF THE INVENTION

The unpublished application DE 102005040179.1 by the Applicant proposes a device for predictively determining a transmission gear ratio change, wherein a correcting module is fed a first proposed gear, drive/vehicle data as well as environment information about the current and anticipated driving environments. The environment data may be navigation data from navigation systems, by which an upcoming driving situation is detected. Furthermore, the environment data may also be determined by environment sensors. In the correcting module, a driving situation is determined in a driving situation module from the data that is received. A driving situation typically corresponds to a curve ahead, a road gradient ahead, an intersection located ahead, a highway entrance or exit ahead or a long straight path ahead. Information about the driving situation is fed to a determining module, in which an adjustment can be made to a first proposed gear. The application, however, does not explain how the change of the first proposed gear can be carried out.

It is, therefore, the object of the present invention to enable a method for the predictive alteration of the first proposed gear, thus improving the spontaneity, sportiness and driving pleasure of motor vehicles with electronically controlled transmissions.

### SUMMARY OF THE INVENTION

This object is achieved with a method for determining a gear ratio change. For determining a change of a first proposed gear, according to the invention, different procedures are proposed. According to the invention, the procedures are determined as a function of a predictively detected driving situation. This means that the procedures are determined as a function of a driving situation located ahead of the vehicle within the length of the intermediate section of road ahead.

Possible processes include maintaining a gear, single downshifting, multiple downshifts, single upshifting or multiple upshifts, or in a special case the stepped single upshift or downshift. A gear in this case shall mean not only a fixed drive position, but in general any arbitrary gear ratio or gear ratio range.

The term “maintain a gear” may mean the suppression of an upshift (upshift suppression), for example when the driver or an assistance system triggers a load decrease. Furthermore, it can also mean a procedure of a predictively triggered upshift or downshift. The procedure can also be carried out during the transition from the predictive shifting strategy, according to the invention, to a conventional shifting strategy, in which, for example, the first proposed gear is determined by a conventional, adaptive gear control unit.

A procedure by means of “downshifting” is carried out when a vehicle brake is engaged. The engagement of the brake can be determined by illumination of the brake light or if the brake pressure exceeds a threshold value. Also during deceleration of the vehicle, further conditions, as well as depression of the accelerator by the driver or an assistance system, a process by downshifting can be carried out. Such a proceeding is likewise performed spontaneously, such as at low engine rotational speeds and other conditions. Deceleration of the vehicle can be determined when the vehicle speed decreases or the gradient of the output rotational speed is negative. Deceleration can also be caused, for example, by releasing the accelerator, by engagement of the brake or by a gradient.

The procedure of “multiple downshifts” is carried out with increased brake pressure, for example. The brake pressure is determined to be elevated as soon as it meets a corresponding brake pressure level. Also the duration of brake pressure application by the driver or the assistance system may cause this procedure. In a further embodiment, such a procedure occurs when any deceleration of the vehicle or a deceleration over an extended period, is detected, as well as when an accelerator is actuated by the driver or the assistance system. Multiple “downshifts” can also be carried out spontaneously at low engine rotational speeds and when a corresponding engine rotational speed level has been met.

The procedure of simple upshifting or multiple upshifts is carried out spontaneously, for example at high engine rotational speeds, when a corresponding engine rotational speed level is met.

The special case of intervening by “stepped single upshifting or downshifting” is carried out during the transition from the predictive proposed gear ratio to the conventional proposed gear ratio. This is to say, when no second proposed gear is formed any longer by the determining module based on a predictively detected driving situation and a switch to the first proposed gear is made.

According to the invention, in the determining module there is at least a two step evaluation whether a change of the First proposed gear by one of the procedures above is carried out or not. In a first step, it is evaluated whether one or more shifting situations for one of the procedures have occurred. If at least one shifting situation has occurred, in principle a corresponding procedure can be carried out. It is also possible, however, that a plurality of shifting situations occurred simultaneously. To ensure that one of the procedures is carried out, additionally the corresponding conditions for performing the procedure must be met. A second step is used to evaluate whether the respective conditions are fulfilled. If the conditions for a procedure exist, a second proposed gear is formed in a subsequent step. The information about this second proposed gear can then be forwarded directly to a transmission. If none of the conditions exist, the first gear proposition is fed to the transmission.

In determining whether a shifting situation for a procedure has occurred, it is always evaluated whether a driving situation has been detected. Only when a driving situation has been detected is a shifting situation for a procedure given. Furthermore, it is advantageously evaluated whether the procedure in the detected driving situation associated with the respective shifting situation is allowed. In addition, it is evaluated in further embodiments whether different dynamic capacities exist. These dynamic capacities include an engine rotational speed level, a gear speed and a transverse acceleration level, wherein the capacities have different definitions for each of the procedures. The engine rotational speed level depends at least on the detected upcoming driving situation, the vehicle speed, the current gear ratio, and the current or anticipated road gradient. In a further embodiment, the engine rotational speed level additionally depends on the detected navigation information and/or on the degree of sportiness. The engine rotational speed may also be identified as the rotational speed present at the transmission input. The gear number function depends at least on the detected driving situation, the current or anticipated road gradient and/or the degree of sportiness and identifies an allowed gear ratio range. The transverse acceleration level depends on the current vehicle speed and/or the degree of sportiness. For the evaluation of the shifting situation, other embodiments also include steps to verify whether other procedures were already carried out in the same driving situation and/or whether there is a difference between the first proposed gear and a second proposed gear.

In determining whether a shifting situation for a “maintain the gear” procedure exists, it is evaluated whether an upcoming driving situation was detected, whether maintaining the gear is permissible in this driving situation ahead, whether the current engine rotational speed meets the dynamic engine rotational speed level, whether the current gear meets a gear speed and/or whether a plausibility check based on vehicle data is met for the predictively detected driving situation and/or whether the vehicle is presently still in the predictively detected driving situation, as a function of the plausibility check, however the situation has not subsided yet. This shifting situation is exited in the event that neither the conditions for performing the “maintain the gear” procedure exist and an upshift request, conventionally triggered by an adaptive gear control unit, exists nor the conditions for performing the “single downshift or multiple downshifts” procedure, nor the conditions for performing the “single decelerating downshift or multiple decelerating downshifts” procedure, nor the conditions for performing the “single spontaneous downshift or multiple spontaneous downshifts” procedure exist and the second proposed gear is lower than the first proposed gear, nor the conditions for performing the “single spontaneous upshift or multiple spontaneous upshifts” procedure exist and the second proposed gear is higher than the first proposed gear.

In the evaluation whether a shifting situation for the “stepped simple maintaining of a gear” procedure exists, it is evaluated whether an upcoming driving situation is detected or whether no driving situation ahead is detected any longer, however a difference exists between the first proposed gear ratio and the second, adapted proposed gear ratio. In one embodiment, it is furthermore evaluated whether the “stepped simple maintaining of a gear” procedure is allowed. Furthermore, the shifting situation for this situation can only occur if the “stepped single downshift” or “stepped single upshift” procedure has already been carried out. An exit from the situation takes place when the first proposed gear ratio and the currently existing gear ratio agree with each other.

In evaluating whether to allow a “single downshift” procedure for a shifting situation, it is evaluated whether an upcoming driving situation is detected, whether the “single downshift” procedure is allowed in this driving situation, whether the expected engine rotational speed, after the single downshift, satisfies the dynamic engine rotational speed level, whether the current transverse acceleration does not exceed the transverse acceleration level, whether the current gear meets the gear speed level and the situation exiting conditions are not met. This situation is exited if the “single downshift” procedure has occurred and, depending on the embodiment, either no brake light signal exists any longer or the current brake pressure drops below a brake pressure level and, furthermore, if either no vehicle deceleration exists any longer or, depending on the embodiment, a brake light signal exists again or the current brake pressure again exceeds the brake pressure function.

In evaluating whether to provide the “multiple downshifts” procedure for a shifting situation, it is evaluated whether an upcoming driving situation is detected, the “multiple downshifts” procedure is allowed in the detected driving situation ahead, the engine rotational speed to be expected after the multiple downshifts meets the dynamic engine rotational speed level, the current transverse acceleration does not exceed the transverse acceleration level, the current gear speed does not drop below the gear speed level or in the event that, with respect to the same driving situation, a single predictive downshift has already been performed, the shifting situation for the “single downshift” procedure is still given. The shifting situation is exited if the “multiple downshifts” procedure has occurred, no vehicle deceleration exists and, depending on the embodiment, if either no brake signal exists any longer or the current brake pressure drops below a brake pressure level or increased brake pressure is no longer applied over a certain amount of time or, depending on the embodiment, if again a brake light signal exists or the current brake pressure again exceeds a brake pressure level.

In evaluating whether to provide the “single decelerating downshift” procedure for a shifting situation, it is evaluated whether an upcoming driving situation is detected, whether the “single decelerating downshift” procedure is allowed in this predicted driving situation, whether the engine rotational speed, to be expected after the downshift, fulfills the dynamic engine rotational speed level, whether the current transverse acceleration does not exceed the transverse acceleration level, whether the current gear does not drop below the gear speed level and the exiting conditions are not met. This shifting situation is exited in the event that a “single decelerating downshift” procedure was carried out and, furthermore, no positive accelerator gradient or electronic accelerator pedal gradient exists and no (noticeable) vehicle deceleration exists. A decelerating downshift describes a downshift which is triggered, based on the vehicle deceleration and further secondary conditions, such as a road gradient or positive accelerator gradient. The vehicle deceleration, however, must not have been created by an actuation of the brake pedal, as is the case with “regular” downshifts.

In evaluating whether to provide the “multiple decelerating downshift” procedure for a shifting situation, it is evaluated whether an upcoming driving situation is detected, the “multiple decelerating downshifts” procedure is allowed in this driving situation and the engine rotational speed, to be expected after the multiple downshift, meets the dynamic engine rotational speed level, the current transverse acceleration does not exceed the transverse acceleration level, the current gear does not drop below the gear speed level or it is evaluated whether, with respect to the same driving situation ahead, a “single decelerating downshift” procedure has already occurred and if the shifting situation for the “single decelerating downshift” procedure exists. This shifting situation is exited in the event that a “multiple decelerating downshifts” procedure was already carried out and no positive accelerator gradient or electronic accelerator pedal gradient exists and no (noticeable) vehicle deceleration exists.

In evaluating whether to provide the “single spontaneous downshift” procedure to the shifting situation, it is evaluated whether an upcoming driving situation is detected, whether a predictive spontaneous downshift is allowed in this predictive driving situation, whether the engine rotational speed to be expected after the downshift fulfills the dynamic engine rotational speed level, whether the current transverse acceleration does not exceed the transverse acceleration level, whether the current gear does not drop below the gear speed level and the conditions for exiting this shifting situation are not met. This situation is exited in the event that a “single spontaneous downshift” procedure has occurred and the second proposed gear corresponds to the current gear.

In evaluating whether to provide the “multiple spontaneous downshifts” procedure to the shifting situation, it is evaluated whether an upcoming driving situation is detected, the “multiple spontaneous downshifts” procedure is allowed in the upcoming driving situation and whether the engine rotational speed, to be expected after the multiple downshifts, meets the dynamic engine rotational speed level, the current transverse acceleration does not exceed the transverse acceleration level, the current gear does not drop below the gear speed level or whether, with respect to the same predictive driving situation, a “single downshift” procedure has already occurred and the shifting situation for a “single downshift” procedure exists. This situation is exited in the event that a “multiple spontaneous downshifts” procedure has already occurred and the second proposed gear corresponds to the current gear.

In Evaluating whether to provide the “single spontaneous upshift” procedure to the shifting situation, it is evaluated whether an upcoming driving situation exists, the “single spontaneous upshift” procedure is allowed in this driving situation ahead, whether the engine rotational speed to be expected after the single upshift meets a dynamic engine rotational speed level and whether the current gear does not drop below a certain gear speed level. This situation is exited in the event that a “single spontaneous upshift” procedure has already occurred and the second proposed gear corresponds to the current gear.

In evaluating whether to provide the “multiple spontaneous upshifts” procedure to the shifting situation, it is evaluated whether a predictive driving situation is detected, whether the “multiple spontaneous upshifts” procedure is allowed in this driving situation and whether the engine rotational speed, to be expected after the multiple upshifts, meets the dynamic engine rotational speed level, whether the current gear does not drop below the gear speed level or whether with respect to the same driving situation ahead, already a “single spontaneous upshift” procedure has occurred and if the shifting situation exists for the “single spontaneous upshift” procedure. This situation is exited in the event that a “multiple spontaneous upshifts” procedure has already occurred and the second proposed gear corresponds to the current gear.

In evaluating whether to provide the “stepped single shift” procedure to the shifting situation, it is evaluated whether a predictive driving situation is detected or whether the predictive driving situation is no longer detected though a difference exists between the first proposed gear and the second, adapted proposed gear, and whether the “stepped single shift” procedure is allowed.

In a second step, it is evaluated, in the determining module, whether the conditions for carrying out the above procedures exist.

In addition, it is evaluated in further embodiments whether different dynamic levels exist. These dynamic levels include an accelerator level and a road gradient, wherein these levels may have different definitions for each procedure.

The accelerator level depends at least on the detected driving situation ahead and the degree of sportiness. The accelerator signal can be derived from the accelerator position, the throttle valve position or the current driving torque. The road gradient level depends at least on the degree of sportiness. In a further embodiment, the road gradient level depends on the current gear and/or on the detected driving situation ahead.

To meet the conditions for carrying out the “maintain the gear” procedure, the shifting situation for the “maintain the gear” procedure must exist, an upshift request, formed by an adaptive gear control unit, must exist as the first proposed gear, which is triggered solely by the adaptive gear control unit or is triggered based on predictively performed procedures, such as “single downshift or multiple downshifts” or a downshift request, formed by an adaptive gear control unit must exist, which is triggered based on the predictively performed procedures, such as “single upshift or multiple upshifts” or in a further embodiment, a load request triggered by the driver or an electronic system must subside.

To meet the conditions for carrying out the “stepped simple maintaining of a gear” procedure, the shifting situation for the “stepped simple maintaining of a gear” procedure must exist, a “single upshift” or “stepped single downshift” procedure must already have been performed and the first proposed gear of the adaptive gear control unit must differ from the second proposed gear, from the determining module.

To meet the conditions for performing the “single downshift” procedure, the shifting situation for the “single downshift” procedure must exist and, depending on the embodiment, either a brake signal must exist or the current brake pressure must exceed a brake pressure level and no other predictive downshift must have been performed in this shifting situation.

To meet the conditions for carrying out the “multiple downshifts” procedure, the shifting situation for this procedure must exist and, depending on the embodiment, either a brake light signal must exist or the current brake pressure must exceed a brake pressure level or a higher brake pressure must be applied for a certain amount of time, and furthermore neither this procedure nor any of the “multiple decelerating downshifts” or “multiple spontaneous downshifts” procedures must have been performed in this shifting situation.

To meet the conditions for carrying out the “single decelerating downshift” procedure, the shifting situation for this procedure must exist, there must be positive pressure on the accelerator or electronic gas pedal, a noticeable vehicle deceleration must exist, a road gradient level must be met, the accelerator position must meet an accelerator level, and no “downshift” procedure must have been performed in this shifting situation.

To meet the conditions for carrying out the “multiple decelerating downshifts” procedure, the shifting situation for the “multiple decelerating downshifts” procedure must exist, there must be positive pressure applied to the accelerator or electronic gas pedal, a noticeable vehicle deceleration must exist, a gear-dependent road gradient level must be met, the accelerator position must meet a situation-dependent accelerator level and neither any of these procedures nor any of the “multiple downshifts” or “multiple spontaneous downshifts” procedures must have been performed in this shifting situation.

To meet the conditions for performing the “single spontaneous downshift” procedure, the shifting situation for the “single spontaneous downshift” procedure must exist, the current engine rotational speed must be below an engine rotational speed level, a road gradient level must be met, the accelerator position must exceed an accelerator level and a downshift must not have yet been performed in this shifting situation.

To meet the conditions for performing the “multiple spontaneous downshifts” procedure, the shifting situation for the “multiple spontaneous downshifts” procedure must exist, the current engine rotational speed must be below an engine rotational speed level, a road gradient level must be met, the accelerator position must exceed an accelerator level and multiple downshifts must not have been performed yet in this shifting situation.

To meet the conditions for performing the “single spontaneous upshift” procedure, the shifting situation for the “single spontaneous upshift” procedure must exist, the current engine rotational speed must exceed an engine rotational speed level, a road gradient level must be met, the accelerator position must exceed an accelerator level and no procedure must have been performed in this shifting situation by which a predictive shift was triggered.

To meet the conditions for performing the “multiple spontaneous upshifts” procedure, the shifting situation for the “multiple spontaneous upshifts” procedure must exist, the current engine rotational speed must exceed an engine rotational speed level, a road gradient level must be met, the accelerator position must exceed an accelerator level and no procedure must have been performed in this shifting situation by which multiple predictive shifts were triggered.

To meet the conditions for carrying out the “stepped single upshift” procedure, the shifting situation for the “stepped single shift” procedure must exist, the difference between the first proposed gear and the second proposed gear from the determining module must be greater than one positive gear level and the “shift gear” procedure must not be pending.

To meet the conditions for carrying out the “stepped single downshift” procedure, the shifting situation for the “stepped single shift” procedure must exist, the difference between the second proposed gear and the first proposed gear must be greater than one positive gear level and the “shift gear” procedure must not be active.

In a further embodiment, the specification for allowing predictive procedures, even for individual shifting situations and individual possible procedures, may be determined directly by the predictive shift procedure system through the evaluation of vehicle data and/or vehicle diagnostic data and/or also (externally) by commands from the conventional transmission control unit and/or by a of the vehicle settings by the driver.

The parameters for the degree of sportiness for influencing predictive procedures may be established in one embodiment directly by the predictive shift procedure system through the evaluation of vehicle data and/or also (externally) by commands from the conventional transmission control unit and/or by a change of the vehicle settings by the driver. As a result of the degree of sportiness, the predictive shift procedure system can better adapt to the different driving styles and requests of different drivers.

Predictively detected driving situations, determined by a predictive driving situation detection unit, based on a navigation unit and/or environment detection sensors/units, may include, for example, a curve ahead, a long straight route located ahead, an intersection ahead, (a slight, medium, high) incline ahead or (a slight, medium, high) decline ahead, city travel/cross-country travel, an entrance or exit ahead, for example to or from a highway or an expressway, a vehicle ahead or the like.

An assistance system could be, for example, a known cruise control system or an ACC system.

In one embodiment, the evaluation of whether a shifting situation for the “maintain a gear” procedure exists and is also broken down into an evaluation, whether a shifting situation for a “predictive gear-maintaining” procedure (upshift optimization) exists and whether a shifting situation for a “maintain gear downshift” procedure, exist for the downshift, decelerating downshift, spontaneous downshift procedures, each single or multiple shifts, and the evaluation whether a shifting situation for the “maintain upshift” procedure (spontaneous single upshift or multiple upshifts) exists. Accordingly, the evaluation of the conditions for performing these procedures is also divided.

In a further embodiment, the evaluation of whether a shifting situation for the “stepped simple maintaining of a gear” procedure exists and is broken down into the evaluation whether a shifting situation for a “stepped single upshift” procedure (for example with dedicated permission and special exit) exists and the evaluation whether a shifting situation for a “stepped single downshift” procedure (for example also with dedication permission and special exit) exists. Accordingly, the evaluation of the conditions for performing these procedures is also divided.

In a further embodiment, the evaluation of whether a shifting situation for the “single shifting” procedure exists and is broken down into an evaluation whether a shifting situation for a “single upshift” procedure (for example with dedicated permission) exists and the evaluation whether a shifting situation for a “single downshift” procedure (for example also with dedication permission) exists. Accordingly, the evaluation of the conditions for performing these procedures is also then divided.

Furthermore, procedures may also be carried out depending on whether the vehicle is pulling a trailer and/or of weather conditions and/or of allowed maximum speeds and if an upcoming driving situation is detected.

In a further embodiment, a “downshift” procedure may be carried out as a function of the vehicle speed if a (potentially tight) curve, a speed limit, a construction site and/or a known accident are predictively detected behind a crest, wherein simultaneously with this procedure a reduction of the driving torque is carried out, if the actuating angle of the accelerator exceeds a certain threshold, an accelerator level or if the vehicle acceleration caused by the procedure would become positive on the traveled gradient or a defined positive threshold were exceeded.

### BRIEF DESCRIPTION OF THE DRAWINGS

The invention will now be described, by way of example, with reference to the accompanying drawings in which:

FIG. 1 is a diagrammatic design of the method, and

FIG. 2 is a flow chart of the method according to the invention.

### DETAILED DESCRIPTION OF THE INVENTION

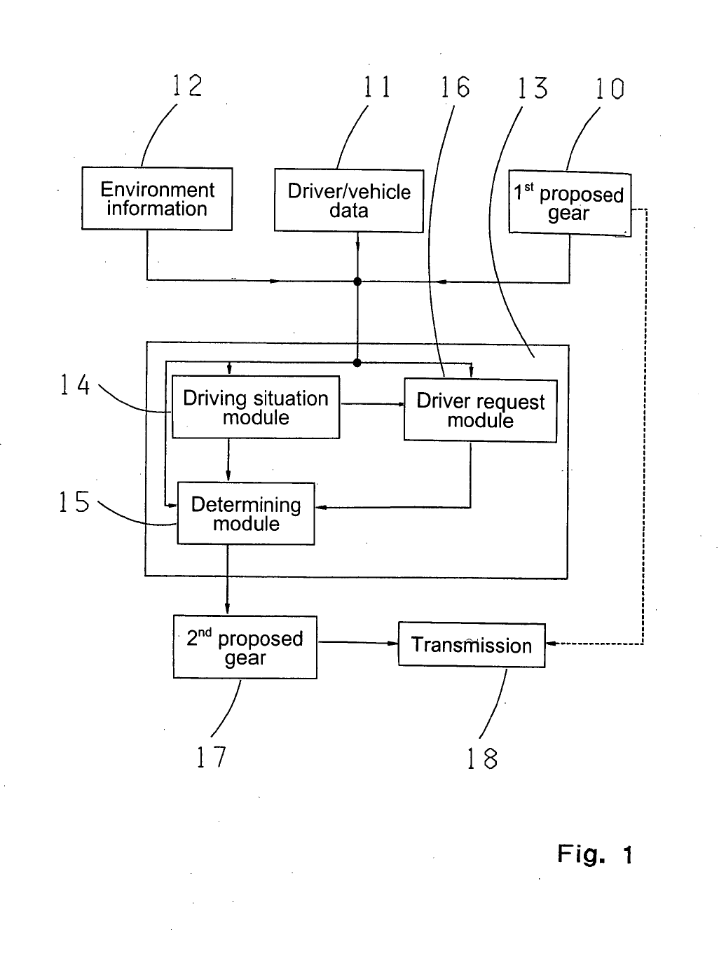

FIG. 1 shows the design of the method. A first proposed gear 10, driver/vehicle data 11 and environment information 12 are forwarded to a correcting module 13. The correcting module 13 comprises a driving situation module 14, a determining module 15 and an optional driver request module 16. The driving situation module receives information about the environment, driver/vehicle data and the first proposed gear (10, 11, 12). An upcoming driving situation is detected as a function of the information that is received. The detected driving situation is forwarded to the driver request module 16 and the determining module 15. The driver request module 16 receives information about the environment, driver/vehicle data and the first proposed gear (10, 11, 12). Furthermore, the driver request module 16 receives information about the detected driving situation and forwards information about the driver request to the determining module 15. The determining module 15 likewise receives information about the environment, driver/vehicle data and the first proposed gear (10, 11, 12). Furthermore, information about the detected driving situation and the existing driver request are forwarded to the determining module 15. In the determining module 15 a decision is then made, based on the information received, whether a procedure will be carried out or not. If a procedure is carried out, information about a second, modified proposed gear 17 is forwarded to a transmission 18. If no procedure occurs, the first proposed gear 10 information is forwarded directly or unchanged to the transmission 18.

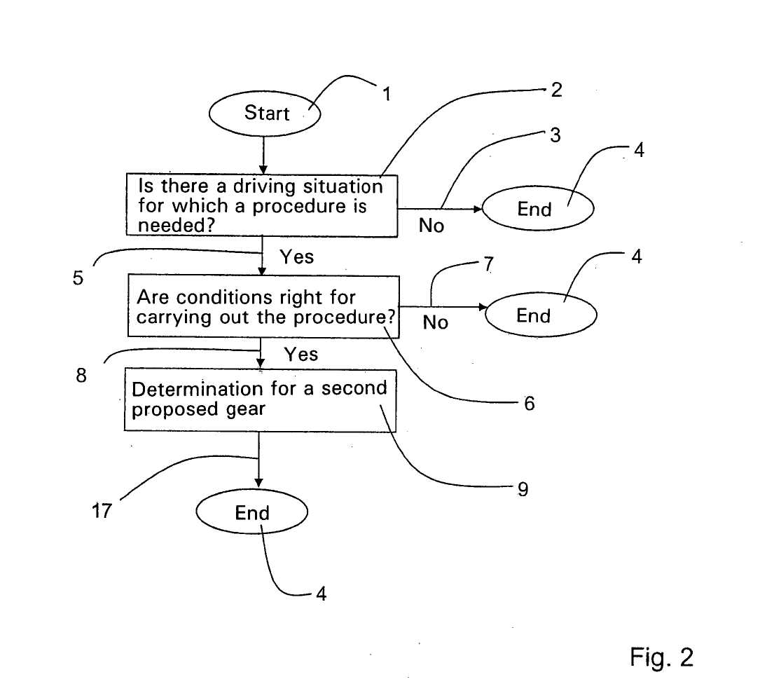

FIG. 2 shows the steps of the method, which are used to decide whether a procedure will be carried out or not. After the start 1, it is evaluated in a first step 2 whether a shifting situation for at least one of the procedures exists. It is also possible that a plurality of shifting situations are given. If no shifting situation exists, a first piece of information 3 is issued and the method is then terminated 4. If at least one shifting situation exists, a second piece of information 5 is issued. Thereupon, it is evaluated in a second step 6 whether the conditions for carrying out the respective procedure exists for one of the detected shifting situations. If the conditions are not met, a third piece of information 7 is issued and the method is terminated 4. If the conditions exist, a fourth piece of information 8 is issued and in a third step 9 a second proposed gear 17 is determined. The second proposed gear 17 information is then issued and the method is terminated 4.

### REFERENCE NUMERALS

1 start
2 first step
3 first piece of information
4 end
5 second piece of information
6 second step
7 third piece of information
8 fourth piece of information
9 third step
10 first proposed gear
11 driver/vehicle data
12 environment information
13 correcting module
14 driving situation module
15 determining module
16 driver request module
17 second proposed gear
18 transmission

1-17. (canceled)

18. A method for determining gear ratio changes in an electronically controlled transmission of a motor vehicle, having correcting module (13) for adapting a first proposed gear (10) depending on environmental data (12), driver/vehicle data (11) and information of a first proposed gear (10), the correcting module (13) having at least one of a driving situation module (14), for detecting at least one of a current driving situation and an anticipated driving situation, and a determining module (15) for determining a second proposed gear (17), depending on information about the detected driving situation, the method further comprising the steps of:
evaluating, in the determining module (15), the existence of at least one shifting situation, needing actuation of a shifting program, depending on the at least one detected driving situation and the driver/vehicle data (11);
evaluating, the existence of proper conditions for actuating the shifting program for the detected shifting situation, if at least one shifting situation exists;
adapting the first proposed gear (10), if the at least one shifting situation has occurred and the conditions for actuating the shifting program exist; and
determining the second proposed gear (17) and forwarding information of the second proposed gear (17) to the transmission (18).

19. The method according to claim 18, further comprising the step of evaluating the existence of the shifting situation, needing actuation of the shifting program, giving consideration to whether, at least one of:
the anticipated driving situation was detected;
a dynamic level of at least one of an engine rotational speed, a gear speed and a transverse acceleration exists;
a shifting program corresponding to the shifting situation is allowed in the detected driving situation;
similar shifting programs were already performed in a like driving situation; and
there is difference between the first proposed gear (10) and the second proposed gears (17).

20. The method according to claim 19, further comprising the step of identifying the dynamic engine rotational speed level as being dependent on at least one of the detected anticipated driving situation, a vehicle speed, a current road gradient, an anticipated road gradient, a detected location and a degree of sportiness.

21. The method according to claim 19, further comprising the step of identifying the dynamic gear speed level as being dependent on at least of the detected anticipated driving situation, a vehicle speed, a current road gradient, an anticipated road gradient and a degree of sportiness.

22. The method according to claim 19, further comprising the step of identifying the dynamic transverse acceleration level as being dependent on at least one of a vehicle speed and a degree of sportiness.

23. The method according to claim 18, further comprising the step of evaluating, in the determining module (15), whether a shifting situation for one of a predictive gear-maintaining process and a stepped simple maintaining of a gear, has occurred.

24. The method according to claim 18, further comprising the step of evaluating, in the determining module (15), whether a shifting situation for one of a predictive single downshift and a multiple downshift, has occurred.

25. The method according to claim 18, further comprising the step of evaluating, in the determining module (15), whether a shifting situation for one of a predictive single decelerating downshift and multiple decelerating downshifts, has occurred.

26. The method according to claim 18, further comprising the step of evaluating, in the determining module (15), whether a shifting situation for one of a predictive single spontaneous downshift and multiple spontaneous downshifts, has occurred.

27. The method according to claim 18, further comprising the step of of evaluating, in the determining module (15), whether a shifting situation for one of a predictive single spontaneous upshift and multiple spontaneous upshifts, has occurred.

28. The method according to claim 18, further comprising the step of evaluating, in the determining module (15), whether a shifting situation for a stepped single shift has occurred.

29. The method according to claim 18, further comprising the step of activating one of a predictive gear maintaining process and a stepped gear maintaining process, if the conditions for carrying out the shifting program exist.

30. The method according to claim 18, further comprising the step of activating one of a predictive single downshift and multiple downshifts, if the conditions for carrying out the shifting program exist.

31. The method according to claim 18, further comprising the step of activating one of a predictive single decelerating downshift and multiple decelerating downshifts, if the conditions for carrying out the shifting program exist.

32. The method according to claim 18, further comprising the step of activating one of a predictive single spontaneous downshift and multiple spontaneous downshifts, if the conditions for carrying out the shifting program exist.

33. The method according to claim 18, further comprising the step of activating one of a predictive single stepped downshift and multiple stepped downshifts, if the conditions for carrying out the shifting program exist.

34. The method according to claim 18, further comprising the step of determining, with the driving situation module (14), the driving situation on a predictive dynamically determined path length of the vehicle.

35. A method for determining gear ratio changes in an electronically controlled transmission of a motor vehicle, the method comprising the steps of:
directing at least one of environmental data (12), driver/vehicle data (1 1) and information of a first proposed gear (10) to a correcting module (13) for consideration in adapting the first proposed gear (10) with the correcting module (13):
detecting at least one of a current driving situation and an anticipated driving situation with a driving situation module (14), associated with the correcting module (13);
forwarding information about the detected driving situation to a determining module (15), associated with the correcting module (13), determine a second proposed gear ratio (17);
evaluating, with the determining module (15), the existence of at least one shifting situation, needing actuation of a shifting program, depending on the at least one detected driving situation and the driver/vehicle data (11);
evaluating, with the determining module (15), the existence of proper conditions for actuating the shifting program for the detected shifting situation, if at least one shifting situation exists;
adapting the first proposed gear (10), if the at least one shifting situation has occurred and the conditions for actuating the shifting program exist; and
determining the second proposed gear (17) and forwarding information of the second proposed gear (17) to the transmission (18).
